(19) United States
(12) Patent Application Publication
(10) Pub. No.: US 2006/0118134 A1
(43) Pub. Date: Jun. 8, 2006

(54) Method and apparatus for treating a surface

(76) Inventor: Nick Griffith, Rancho Palos Verdes, CA (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/007,022

(22) Filed: Dec. 8, 2004

(51) Int. Cl. B08B 7/00; B63B 59/06

(52) U.S. Cl. 134/6; 114/222; 15/52.1; 15/383

(57) ABSTRACT

A method of treating a surface such as a ferrous surface. The method includes the steps of: providing an apparatus having a carriage and a treating assembly on the carriage; causing the apparatus to be attracted to the ferrous surface with a force that tends to maintain the apparatus against the ferrous surface yet allows the apparatus to move over the ferrous surface; and moving the apparatus over the ferrous surface to effect treating of the ferrous surface with the treating assembly through manual orientation and movement of the apparatus by a user through application of a maneuvering force by a user from a location spaced from the carriage that allows controlled movement of the apparatus over the ferrous surface.

### BACKGROUND OF THE INVENTION

1. Field of the Invention

This invention relates to a portable apparatus that can be attracted, and moved relative, to a surface to facilitate treatment thereof. The invention is further directed to a method of using such an apparatus.

2. Background Art

Cargo ships, especially dry cargo and liquid bulk ships, are used to transport a wide range of products and materials on waterways worldwide. In one known dry cargo ship construction, multiple cargo holds are formed in the ship's hull to accept bulk quantities of particulate material. Each cargo hold is bounded by a ferrous wall structure and has an overhead access for loading and unloading of the materials. A typical cargo hold may have length and width dimensions on the order of 100 feet and a height on the order of 60 feet.

A description of the transportation of powdered cement in a dry bulk cargo ship will be provided herein below to demonstrate some of the problems that have plagued this industry. In a typical operation, a cargo hold will be filled with the cement at a load port. At the destination port, the cement is discharged. Loading and discharge of the cement is carried out using any of a number of different, well-known techniques and equipment. These techniques are designed to remove the majority, but not all of the bulk cargo. The balance of the residual cargo, as well as other debris, loose rust, scale, paint and other potential contaminants such as stains must also be removed prior to loading another cargo at the same or a different load port.

In the event that the hold is refilled with cement, the preparation of the hold for reloading may be minimal. However, if the next cargo is different, the walls of the hold must be appropriately cleaned so as to not contaminate the new product with the cement residue that adheres to the walls, overhead and other structures and fittings within the hold and hatch covers.

Heretofore, the cleaning of the walls and other surface within the hold of a cargo hold has been time and labor intensive and has further required relatively expensive equipment. Commonly, ladders are sometimes used to clean the lower areas of the hold, and a lift structure is often introduced to each hold to clean the upper areas. Each lift consists of a self-powered vehicle with a repositionable support for a bucket, within which a worker resides during the cleaning process. The vehicle must be strategically maneuvered into different locations to allow the worker to access the full areal expanse of the cargo hold walls.

The shipping industry has utilized the above techniques for decades and has contended with a number of problems associated therewith due to the fact that better alternatives have not been available, especially to clean inaccessible areas of the hold and hatch covers. First of all, this type of cleaning equipment is relatively expensive for a number of reasons including the necessary delivery time and costs from anchor. The cleaning of the ship is very slow because only a few workers on the lift are able to clean the ship at one time. The refilling and deployment of the ships are therefore delayed, with a consequent loss of revenue.

Second, these conventional vehicles require that the workers be elevated to heights that are inherently dangerous. Personnel manning these vehicles must thus have a relatively high skill level and exercise extreme care to avoid injury. The use of ladders at this height also causes workers to be precariously situated.

Third, the size and configuration of a hold may limit the number of vehicles that can function at the same time therein. The use of a single vehicle in each hold may delay the cleaning process for days, during which cleaning and docking expenses are incurred without any generation of revenue.

Fourth, if multiple vehicles are operated at the same time in a given hold, an even higher level of skill in operation may be required to coordinate the efforts of the workers in an efficient and safe manner. Safety and efficiency are further challenged by reason of the fact that these operations, to remove fine particulate cement, may cause the particles to be entrained in the air and completely fill the space in the hold, which impairs visibility and additionally exposes the workers to health risks associated with inhalation of these particles.

Fifth, these vehicles are generally powered by fuels that cause by product emissions that become confined in the hold. This introduces an additional health risk to the workers and limits the times when the ship can be cleaned. During periods of precipitation the holds cannot be cleaned due to the dangerous emissions.

The shipping industry is highly competitive. Consequently, efficiency becomes a primary focus of those in this industry. A ship in port is doing nothing more for its owner/operator/charterer than generating expenses. Any crew that is not participating in the cleaning process is being paid for down time. Docking and other fees accrue on a daily basis, and charter times are usually calculated in six minute intervals. Thus, it is clearly in the interest of the owner/operator to quickly, safely and efficiently clean the cargo holds and refill the same to allow transportation of materials and generation of income after the ship is certified clean and placed “on hire”. Unfortunately, an emphasis on efficiency may cause a compromise in safety in the cleaning operations. Even on an expedited schedule, however, the preparation of five to nine separate cargo holds may take as long as 3-5 days or longer. During the transition from bulk cement powder to another bulk cargo, the process of cleaning usually comprises two parts: dry cleaning and wet cleaning. The lifts are used during the dry cleaning. The tools and methods of this invention will dramatically improve the speed, efficacy and safety of both processes, and will often entirely eliminate the need for the dry cleaning phase, usually conducted at anchor after initial discharge. The invention will also extend the ability of relatively unskilled workers to further prepare the holds for subsequent cargo by giving them the tools they need to remove not only residual cargo, but also loose paint, rust, scale, and other potential contaminants from areas previously inaccessible to effective cleaning. Further, it will provide crews with an alternative method of stain removal, which has previously been accomplished with the use of acids and other dangerous and polluting chemicals, and a much improved method of protective chemical application.

The industry continues to seek out equipment and techniques to more effectively, efficiently, and safely clean cargo holds.

### SUMMARY OF THE INVENTION

In one form, the invention is directed to a method of treating a surface such as a ferrous surface. The method includes the steps of: providing an apparatus having a carriage and a treating assembly on the carriage; causing the apparatus to be attracted to the ferrous surface with a force that tends to maintain the apparatus against the ferrous surface yet allows the apparatus to move over the ferrous surface; and moving the apparatus over the ferrous surface to effect treating of the ferrous surface with the treating assembly through manual orientation and movement of the apparatus by a user through application of a maneuvering force by a user from a location spaced from the carriage that allows controlled movement of the apparatus over the ferrous surface.

In one form, the step of providing an apparatus involves providing an apparatus with at least one wheel that rolls against the ferrous surface.

The step of causing the apparatus to be attracted to the ferrous surface may involve causing the apparatus to be magnetically attracted to the ferrous surface.

In one form, the ferrous surface defines a wall bounding a cargo hold on a ship.

In one form, the step of moving the apparatus over the ferrous surface involves moving the apparatus over the ferrous surface using a flexible cord or elongate pole.

The step of providing an apparatus may involve providing an apparatus with a treating assembly that has a bristled element.

The step of providing an apparatus may involve providing an apparatus with a treating assembly that has a rotary brush.

In one form, the step of providing an apparatus involves providing an apparatus with a treating assembly having a treating element that is movable relative to the carriage.

The method may further include the step of urging at least a part of the treating assembly in movement relative to the carriage to bias a treating element on the treating assembly against the ferrous surface.

The method may further include the step of inducing vibration to a treating element on the treating assembly.

In one form, the step of providing an apparatus involves providing an apparatus with a drive element on the carriage for causing the treating element to be moved relative to the carriage.

At least one of the wheels may be driven to cause the apparatus to move over the ferrous surface.

The step of providing an apparatus may involve providing an apparatus having a treating assembly that discharges a fluid against the ferrous surface.

The step of providing an apparatus may involve providing an apparatus having a treating assembly with a treating element that repetitively impacts the ferrous surface to produce a hammering action.

The step of providing an apparatus may involve providing an apparatus with a treating assembly that is either electrically or pneumatically powered.

The method may further include the step of placing the apparatus against the ferrous surface using the elongate pole.

The method may further involve the steps of providing a supplemental support system and through the supplemental support system facilitating movement of the apparatus in conjunction with the elongate pole.

The step of providing a supplemental support system may involve providing at least one flexible element and the step of facilitating movement of the apparatus may involve exerting an upward force on the apparatus through the supplemental support system.

The method may further include the step of selectively varying the force that tends to maintain the apparatus against the ferrous surface.

The step of providing an apparatus with a bristled element may involve providing an apparatus with a bristled element that is movable to advance the carriage independently of a force exerted by a user tending to move the treating apparatus relative to the ferrous surface.

The step of providing an apparatus may involve providing an apparatus with a non-ferrous core element with a surface treating layer provided over the core element.

The step of providing an apparatus may involve providing an apparatus with a surface treating layer that is at least one of: a) sandpaper; b) an absorbent pad; c) a bristled layer; d) a layer of hook component of a hook and loop fastener system; and e) a non-skid layer.

The method may further include the step of applying a treating substance to the ferrous surface through the treating assembly.

The method may further include the step of heating the ferrous surface through a heat source on the carriage.

The step of providing an apparatus may involve providing an apparatus with treating elements that are interchangeably mountable in an operative position on the carriage.

The step of providing an apparatus may involve providing an apparatus with a treating element that is contoured to engage and conform to other than a flat surface.

The step of providing an apparatus may involve providing an apparatus through which suction can be generated to controllably draw foreign matter away from the ferrous surface.

The step of providing an apparatus may involve providing an apparatus with a source of illumination on the carriage.

The step of providing an apparatus may involve providing an apparatus with a video camera on the carriage to facilitate viewing by a user of a treating process.

In one form, the step of providing an apparatus involves providing an apparatus with at least one mirror on the carriage that facilitates observation by a user of the ferrous surface either before or after treatment thereof.

The method may further include the steps of providing at least one collection element, causing foreign matter removed from the ferrous surface to be directed against the collection element as it is removed, and reconfiguring and relocating the collection element with the accumulated foreign matter.

The method may further include the steps of providing a human lift device and operating the apparatus from the human lift device.

The method may further include the step of repetitively impacting the ferrous surface to produce a hammering action preparatory to using the apparatus.

The method may include the step of inducing vibration to a portion of the ship preparatory to using the apparatus.

The invention is further directed to an apparatus for treating a ferrous surface. The apparatus has a carriage, a treating assembly on the carriage, and a magnetic assembly for attracting the apparatus to the ferrous surface with a force tending to maintain the apparatus against the ferrous surface yet allow the apparatus to move over a ferrous surface. The overall apparatus configuration is such as to be movable over a ferrous surface and controllably reoriented and moved through the application of a maneuvering force upon the apparatus by a user from a location spaced from the carriage.

The apparatus may further include an elongate pole attached to the carriage and through which the user can apply the maneuvering force.

Alternatively, a flexible element may be attached to the carriage through which the user can apply the maneuvering force.

In one form, the carriage has at least one wheel that rolls against a surface to be treated.

The treating assembly may include a bristled element.

The treating assembly may include a rotary element.

In one form, the rotary element has bristles thereon that are oriented to cause the rotating element to generate a force that tends to advance the apparatus over a surface to be treated as the rotary element is operated.

In one form, a biasing assembly exerts a force on the treating element tending to move the treating element relative to the carriage.

The apparatus may further include a vibration generator through which the treating element is vibrated.

The apparatus may include a drive for rotating the at least one wheel.

The apparatus may further include a fluid and/or compressed air or gas discharge assembly through which a fluid or gas under pressure is discharged at a treating location.

One or more discharge nozzles may be provided on the carriage through which fluid under pressure can be directed at a surface to be treated.

The apparatus may include an impact assembly on the carriage for repetitively impacting a surface to be treated to produce a hammering action.

The treating apparatus may further include at least one movable component, with the movable component being driven either electrically or pneumatically.

The magnetic assembly may include at least two magnets that can be interchangeably mounted on the carriage.

In an alternative design, the carriage has a receptacle for plurality of magnetic elements defining the magnetic assembly and the attracting force is variable by at least one of: a) changing the number of magnetic elements placed in the receptacle; b) using magnetic elements with different capacity; and c) changing the distance between the magnetic elements and the ferrous surface.

In one form, the carriage has a non-ferrous core element to which a surface treating layer is applied.

The surface treating layer may be at least one of: a) sandpaper; b) an absorbent pad; c) a bristled layer; d) a layer of a hook component of a hook and loop fastener system; e) a non-skid layer; f) squeegee; and g) absorbent pad.

The apparatus may further include a heat source on the carriage.

In one form, the treating assembly has a treating element that is releasably mountable in an operable position on the carriage. A second treating element may be provided that can be mounted in an operative position on the carriage in place of the first described treating element.

In one form, the first described and second treating elements have different configurations.

The apparatus may further include a vacuum source for generating suction at an area being treated to thereby draw away foreign matter separated from a surface being treated.

The apparatus may include a source of illumination on the carriage.

In one form, at least one mirror is provided on the carriage to facilitate observation by the user of a surface being treated either before or after treatment thereof.

A video camera or mirror may be provided on the carriage to facilitate viewing of a treating process by a user.

The apparatus may further include a collection receptacle, with foreign matter separated by the treating assembly directed into the collection receptacle.

The treating assembly may be vibrated relative to the carriage to facilitate treating of a ferrous surface.

The treating assembly may be movable reciprocatively relative to the carriage to facilitate treating of a ferrous surface.

A drive may be provided for the at least one wheel.

### BRIEF DESCRIPTION OF THE DRAWINGS

FIG. 1 is a schematic representation of one form of treating apparatus, according to the present invention, in relationship to a surface, to which the treating apparatus is attracted, and which surface is treated with a treating assembly on the inventive apparatus;

FIG. 2 is a schematic representation of the inventive treating apparatus in relationship to a ferrous surface to which the treating apparatus is attracted through a magnetic assembly;

FIG. 3 is a schematic representation of the inventive treating apparatus with the treating assembly attached to the carriage that acts against a ferrous or non-ferrous surface to be treated;

FIG. 4 is a schematic representation of the treating assembly in FIG. 3 and including a treating element that directly contacts a surface to be treated;

FIG. 5 is a perspective view of a cargo ship having a cargo hold which can be treated using the inventive apparatus and by a method according to the present invention;

FIG. 6 is an enlarged, fragmentary, perspective view of one of the holds on the cargo ship in FIG. 5 and with one form of the inventive apparatus being maneuvered by a user to treat a surface bounding a storage space defined by the cargo hold;

FIG. 7 is an enlarged, fragmentary, perspective view of the inventive apparatus shown in FIG. 6;

FIG. 8 is an enlarged, front elevation view of the inventive apparatus in FIG. 7;

FIG. 9 is an enlarged, side elevation view of the inventive apparatus in FIGS. 7 and 8 in relationship to a surface being treated;

FIG. 10 is an enlarged, perspective view of the carriage on the inventive apparatus in FIGS. 7-9;

FIG. 11 is an enlarged, exploded, perspective view of the carriage in FIG. 10;

FIG. 12 is a front elevation view of the carriage in FIGS. 10 and 11;

FIG. 13 is a schematic, side elevation view of a modified form of treating element for the inventive treating assembly;

FIG. 14 is a view as in FIG. 13 of a further modified form of treating element;

FIG. 15 is a schematic representation of the inventive carriage having a generic form of impacting assembly thereon of the type shown in FIG. 14;

FIG. 16 is a schematic representation of the carriage, according to the present invention, and including a heat source;

FIG. 17 is view as in FIG. 16 wherein the carriage includes an illumination source;

FIG. 18 is a view as in FIGS. 16 and 17 wherein the carriage includes at least one mirror;

FIG. 19 is a view as in FIGS. 16-18 wherein the carriage includes a video camera;

FIG. 20 is a schematic representation of a carriage, according to the present invention, including at least one nozzle for directing pressurized fluid and/or air or gas from a supply to against a surface being treated;

FIG. 21 is a schematic representation of a carriage, according to the present invention, and including at least one opening in communication with a vacuum source to develop suction at the opening and a receptacle for accumulating foreign material drawn through the opening(s);

FIG. 22 is a schematic representation of a cargo hold with a flexible collecting element therein;

FIG. 23 is a view as in FIG. 22 wherein the collecting element, with foreign material accumulated therein, is being reconfigured and elevated towards an opening through a boom structure;

FIG. 24 is a view as in FIGS. 22 and 23 wherein the collecting element is further elevated and reconfigured to allow passage through the opening;

FIG. 25 is a schematic representation of a carriage, according to the present invention, including a vibration inducing assembly for part or all of the treating assembly;

FIG. 26 is a view as in FIG. 25 wherein a reciprocating assembly is provided in place of the vibration inducing assembly;

FIG. 27 is a schematic representation of a carriage, according to the present invention, including a treating element that is moved through a drive;

FIG. 28 is a schematic representation of a carriage, according to the present invention, including at least one wheel that is driven so that the carriage is self-propelled;

FIG. 29 is a schematic representation of the inventive carriage having a movable component/function that is operated electrically;

FIG. 30 is a schematic representation, corresponding to that in FIG. 29, wherein the movable component/function is operated hydraulically or pneumatically;

FIG. 31 is a flow diagram representation of one method of treating a surface, according to the present invention;

FIG. 32 is a flow diagram representation of another method of treating a surface, according to the present invention;

FIG. 33 is a schematic representation of a kit, according to the present invention, including a carriage with interchangeable treating elements;

FIG. 34 is a view as in FIG. 33, wherein interchangeable treating assemblies are provided;

FIG. 35 is a plan view of a treating element, according to the present invention, for accessing a surface at the juncture of two transverse surfaces;

FIG. 36 is a schematic, side elevation view of a user operating the inventive apparatus from a bucket on a human lift device;

FIG. 37 is a schematic representation of an impact/vibration inducing device for acting against a part of a cargo ship preparatory to treating a surface thereon, according to the present invention;

FIG. 38 is an elevation view of a pad, according to the present invention, through which a surface can be treated, and which includes a core element/carriage that is magnetically attracted to a ferrous surface, wherein a magnetic element is embedded in the core element;

FIG. 39 is a view as in FIG. 38 wherein magnetic elements are mounted to an exposed surface of the core element/carriage;

FIG. 40 is a view as in FIGS. 38 and 39 in combination with magnetic elements that can be selectively placed in receptacles to select a desired magnetic attractive force;

FIG. 41 is a modified form of treating apparatus, according to the present invention, in the form of a pad with an associated magnetic element for attracting the pad to a ferrous material and including a flexible cord for maneuvering the pad;

FIG. 42 is a flow diagram representation of another method of treating a surface, according to the invention, using the pad in FIG. 41;

FIG. 43 is a schematic representation of a modified form of apparatus, according to the present invention, including a pivot connection between an elongate operating pole and carriage;

FIG. 44 is a fragmentary, schematic representation of a further modified form of elongate pole, according to the invention, which is connected to a carriage with a reciprocating assembly associated therewith to impart a reciprocating action to the carriage; and

FIG. 45 is a fragmentary, elevation view of a further modified form of treating apparatus, according to the present invention, including rotary treating elements that are operated pneumatically.

### DETAILED DESCRIPTION OF THE DRAWINGS

In FIG. 1, a treating apparatus, according to the present invention, is shown at 10. The treating apparatus 10 has a treating assembly 12 that is designed to perform a treating function with respect to a surface 14. The nature of the treating operation is not critical to the present invention. Virtually any treatment process, from cleaning to reconfiguration, is contemplated. FIG. 1 is shown in schematic form to encompass all types of surface treating operations.

According to the invention, the treating apparatus 10 is attracted to the surface 14 with a force tending to maintain the apparatus 10 against the surface 14, yet allow the apparatus 10 to move over the surface 14 to treat a desired area thereof. This force is generated through what is schematically shown as an attractive force generation system 16, which may take any of myriad different forms. As just one example, the attractive force generation system 16 may use vacuum to generate a suction force between the treating apparatus 10 and the surface 14. Alternatively, magnetic attraction can be utilized for surfaces 14 that are ferrous in nature. Again, this system 16 is shown generically in FIG. 1 to encompass virtually any type of structure that attracts the apparatus 10 to the surface 14, while allowing the apparatus 10 to move therealong to effect treatment of a prescribed area.

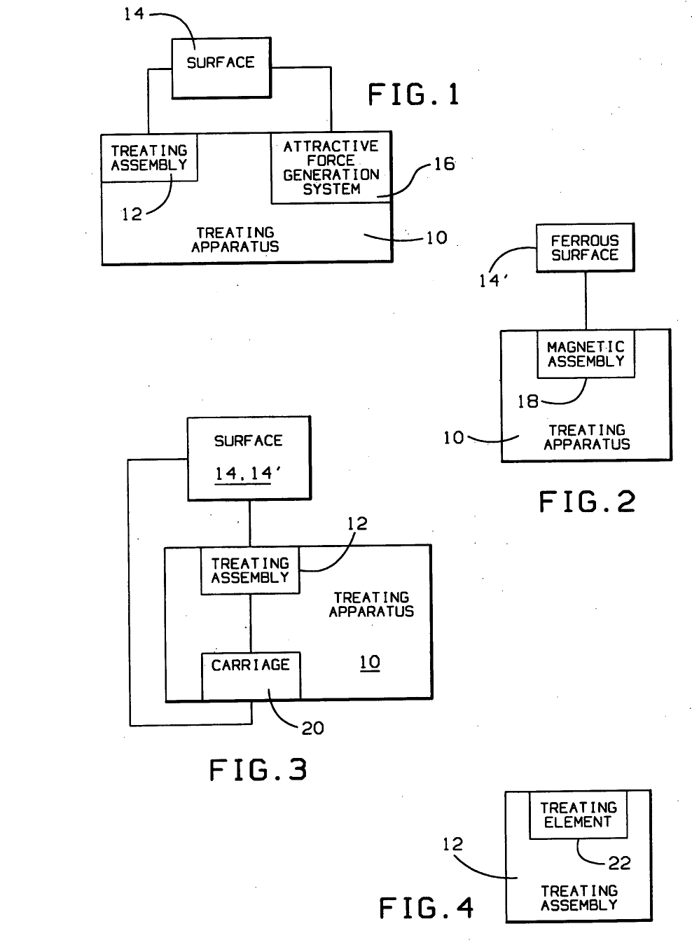

As shown in FIG. 2, one preferred form of attractive force generation system incorporates a magnetic assembly 18, which is attracted to a surface 14′ that is ferrous in nature.

In one preferred generic configuration for the apparatus 10, as shown in FIG. 3, the carriage 20 acts directly against the surface 14, 14′. The treating assembly 12 is mounted operably upon the carriage 20 to act against the surface 14, 14′.

As shown in FIG. 4, the treating assembly 12 can incorporate any of a virtually limitless number of different treating elements, shown generically at 22.

What is common to the designs shown in FIGS. 1-4 is that the treating apparatus 10 has an overall configuration to be movable against a surface and controllably reoriented through the application of a maneuvering force upon the apparatus 10 by a user from a location spaced from the carriage 20. Ideally, the treating apparatus 10 is of such a construction that it can be easily lifted by a user, placed against the surface 14, 14′, and moved and reoriented without excessive exertion on the part of the user.

The designs in FIGS. 1-4 are shown schematically to incorporate virtually a limitless number of different designs that use the inventive concept(s) described herein. Various, specific designs, and methods of using the apparatus 10, will now be described, with it to be understood that the specific examples are intended to be representative, but not limiting, in nature.

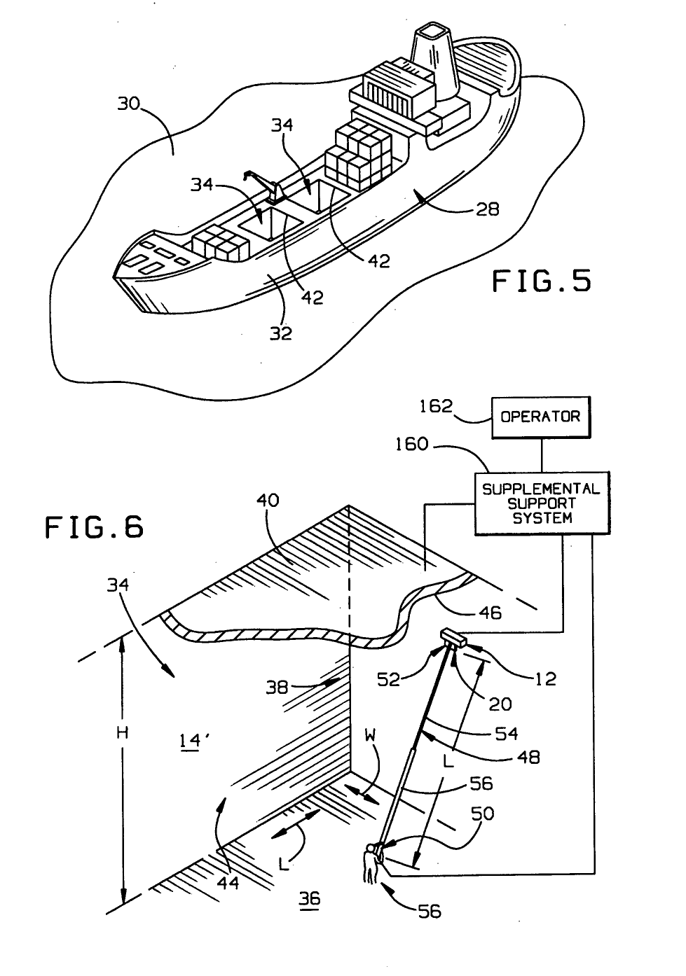

More specifically, as shown in FIGS. 5 and 6, the treating apparatus 10 has particular utility in the shipping industry. As noted in the Background portion herein, treating/cleaning of holds in cargo ships is a particularly vexatious problem, for which the present invention is particularly suited. In FIG. 5, a cargo ship is shown at 28 and is of the type useable on any navigable body of water 30. The ship 28 has a hull 32 within which cargo holds 34 are formed. In this particular design, two such cargo holds 34 are shown. In a more typical ship construction that is currently used, more than two, and commonly five, cargo holds 34 are incorporated. However, the number and configuration of the cargo holds 34 is not critical to the present invention.

In FIG. 6, a portion of one of the holds 34 is shown in relatively schematic form. The cargo hold 34 is bounded by a ferrous surface 14′. The ferrous surface 14′ defines a floor 36, a peripheral wall structure 38, and a deck wall 40, through which openings 42 are formed. The openings 42 are in communication with a storage space 44 within the holds 34. Materials are introduced to, and withdrawn from, the holds 34 through the openings 42.

The hold 34 is shown in a simplified, schematic form. In actuality, there are a number of contours within the storage space 44 that make cleaning of the surface 14′ difficult. Additionally, a staircase and other structure are typically constructed within the space 44 and define obstacles to cleaning.

As noted in the Background portion herein, the cargo hold 34 may have length and width dimensions, designated by the double-headed arrows L, W, respectively, on the order of 100 feet. The height dimension H, between the floor 36 and ceiling 46, may be on the order of 60 feet.

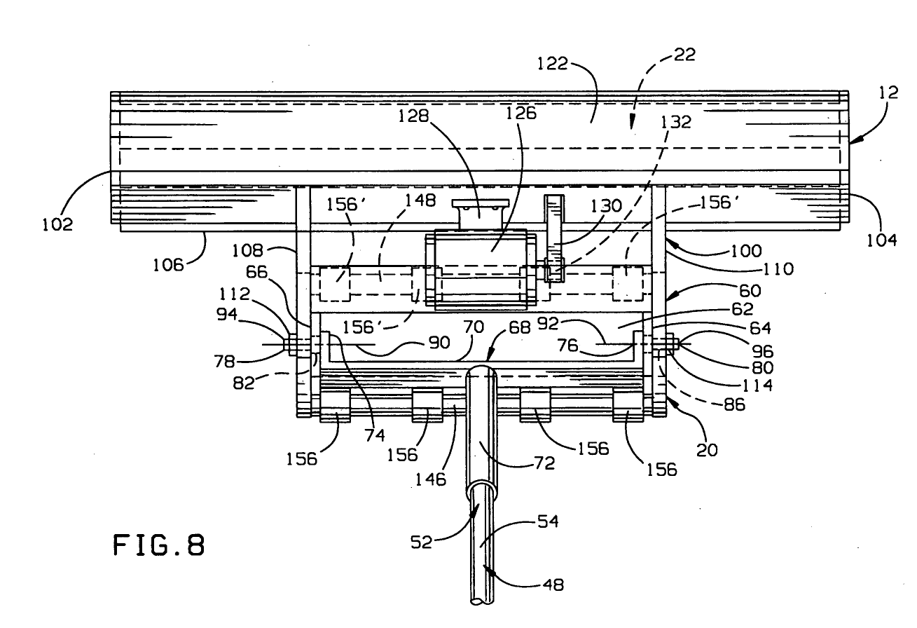

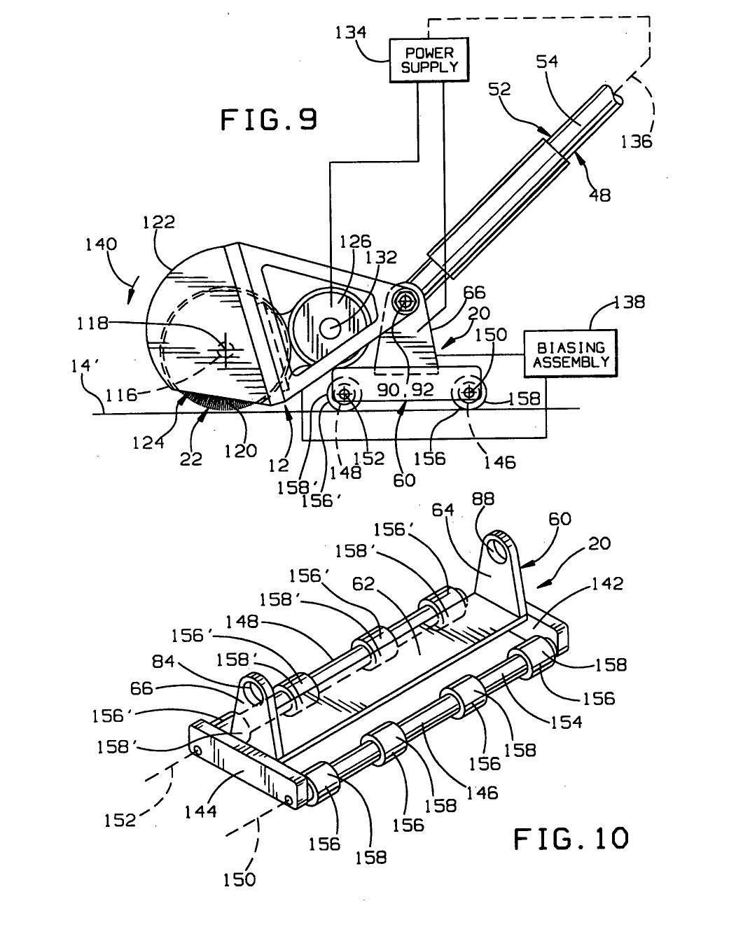

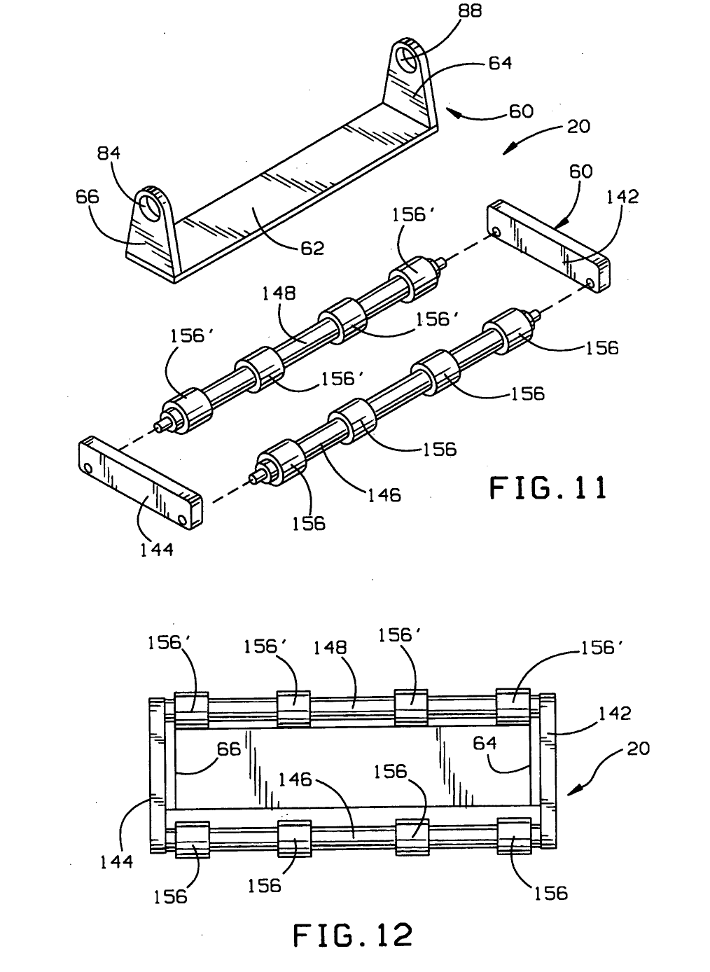

In one form of the invention, shown in FIGS. 6-12, the apparatus 10 consists of the carriage 20, with the treating assembly 12 mounted operatively thereupon. The carriage 20 is connected to an elongate pole 48 through which the treating apparatus 10 is reoriented and moved to cover a desired areal region.

The pole 48 may have a fixed length L between a manipulating end 50 and a carriage mounting end-52. More preferably, the pole 48 is made with telescoping lengths 54, 56. While two such lengths 54,56 are shown, any number of lengths can be utilized.

The nature of the pole components is not critical to the present invention. It is desirable that the pole 48 be light in weight to allow controlled manipulation thereof and the attached treating apparatus 10 by a user at 58 from the floor 36 to access the entire surface 14′, to include the portion thereof defining the entire peripheral wall structure 38 and the ceiling 46. The telescoping lengths 54, 56 may be made from a lightweight metal, plastic or composite, etc. At the same time, the pole 48 must have sufficient rigidity to allow controlled placement by the user 58 of the treating apparatus 10 and maneuvering thereof across the surface 14′.

The pole 48 may be straight, as shown, or shaped to access certain obstructed areas. As just one example, a “gooseneck” may be provided on the end of the pole 48.

In this embodiment, the carriage 20 has of a frame 60 consisting of a base element 62, that is generally flat, with spaced flanges 64, 66 projecting substantially orthogonally therefrom.

The flanges 64, 66 support a pole mounting assembly at 68, consisting of a crosspiece 70 and a transverse receptacle 72 for the carriage mounting end 52 of the pole 48. The crosspiece 70 has offset ends 74, 76 with stub shafts 78, 80 projecting oppositely away therefrom. The shafts 78, 80 have a like construction. The stub shaft 78 has a larger diameter portion 82 that is journalled for rotation in an opening 84 in the flange 66. The stub shaft 80 has a larger diameter portion 86 that is journalled for rotation in an opening 88 in the flange 64. The stub shafts 78, 80 have central axes 90, 92 that are coincident and about which the pole mounting assembly 68 is pivotable for movement relative to the frame 60. The stub shafts 78, 80 have smaller diameter portions 94, 96 that are threaded and define a support for the treating assembly 12, to allow the treating assembly 12 to pivot about the same axes 90, 92 relative to the frame 60.

The treating assembly 12 has a subframe 100, consisting of spaced end walls 102, 104 joined by a mounting wall 106. Triangularly-shaped mounting brackets 108, 110 are connected to the mounting wall 106 and are spaced so as to closely embrace the flanges 64, 66. The smaller diameter portions 94, 96 of the stub shafts 78, 80 project through the mounting brackets 108, 110, which are secured in place by nuts 112, 114. Through this arrangement, the subframe 100 is pivotable relative to the frame 60 about the same axes 90, 92.

In this embodiment, the treating element 22 is in the form of a rotary brush. The treating element 22 has a central shaft 116 which spans between the end walls 102, 104 and is journalled for rotation relative thereto around an axis 118, that is generally parallel to the axes 90, 92. Individual bristles 120 extend radially relative to the axis 118 regularly around the circumference of the shaft 116 and along the length thereof. The subframe 100 includes an integral shroud 122 with an opening 124 through which the bristles 120 are exposed.

A drive motor 126 is mounted to the mounting wall 106 on the subframe 100 through a bracket 128. A belt 130, extending in an endless path around the motor shaft 132 and central shaft 116 on the treating element 22, transmits the driving force of the motor to effect rotation of the treating element 22 around the axis 118.

The drive motor 126 is powered through a supply 134. The power supply 134 can be self-contained and mounted upon the carriage 20. Alternatively, as shown in dotted lines, a supply line 136 can be directed over and through the hold 48 to a remote location where a power supply 134 is located. For example, the power supply 134 may be a remote generator or accessed through a receptacle within the cargo hold 34 associated with the power supply 134.

The treating assembly 12 may have a fixed position relative to the carriage 20. More preferably, the treating assembly 12 is pivotable about the axes 90, 92 relative to the carriage 20 such that the treating element 22 is movable towards and away from the surface 14′. Preferably, a biasing assembly 138 acts between the carriage 20 and treating assembly 12 to normally bias the treating assembly 12 in the direction of the arrow 140 around the axes 90, 92. With the carriage 20 bearing against the surface 14′, this biasing force urges the treating element 22 towards and against the surface 14′.

The nature of the biasing assembly 130 is not critical to the present invention. For example, the biasing assembly 138 may be defined by one or more tension or compression springs. Alternatively, a torsion spring may be utilized for this purpose. Alternatively, pneumatic cylinders might be utilized to exert a constant force and provide some flexibility in movement of the treating assembly 12 about the axes 90, 92, oppositely to the direction of the arrow 140.

In this embodiment, the carriage 20 is equipped with structure to allow it to be rolled against the surface 14′ and also to be attracted thereto, as previously described. More specifically, spaced mounting blocks 142, 144 are fixed to the base 62 to support rotary wheels/shafts 146, 148, for rotation around parallel axes 150, 152. The wheels/shafts 146, 148 have the same construction. The exemplary wheel/shaft 146 has a core 154 around which axially spaced wheel elements 156 are formed. Each wheel element 156 defines a peripheral surface for rolling against the surface 14′. Each wheel element 156 is made from, or incorporates, a magnetic material that is attracted to the ferrous surface 14′. The wheel/shaft 148 has corresponding wheel elements 156′ with peripheral surfaces 158′.

The magnetic material is incorporated depending upon the overall weight and configuration of the treating apparatus 10, including the pole 48. That is, the size, strength, and location of the magnetic material can be appropriately selected so that the attractive force between the treating apparatus 10 and the surface 14′ will urge the carriage 20 against the surface 14′ during the treating of all regions of the surface 14′ within the cargo hold 34.

In the absence of this attractive force, the maintenance of the carriage 20 in contact with the surface 14′ is dependent upon the user's ability to generate an adequate applying force. This is particularly a problem with overhead surfaces, such as the ceiling/overhead 46, and also with the treating assembly 12 manipulated through the pole 48 to the upper regions of the cargo hold 44. For example, as shown in FIG. 6, in the absence of this attractive force, the pole 48 has a tendency to bow at extreme lengths such that the treating assembly 12 tends to move out of contact with the surface 14′. Selecting an appropriate magnetic attraction force overcomes this problem.

Even with the magnetic attraction, the treating assembly 12 may be difficult to manipulate through the pole 48 at extreme heights. To facilitate this manipulation, and additionally for purposes of added safety and avoiding user fatigue, a supplemental support system can be provided, as shown at 160. The supplemental support system 160 may be attached, as to the deck wall 40, and extends to the treating assembly 12 and/or the pole 48. The supplemental support system 160 may include flexible elements, such as cables, ropes, bungees, etc., and use pulleys, etc., to produce a vertical and/or horizontal locating force upon the treating apparatus 10. The supplemental support system 160 may be fixed, or may be reconfigurable, as through the operator, or through a remote operator 162, as shown in FIG. 6, during a cleaning operation.

The nature of the treating assembly 12 can vary considerably depending upon the particular treating procedure that is being carried out. For example, in the embodiment described above, the bristles 120 can be made with different configurations and from different materials. The bristles 120 may be made, for example, from plastic or metal. The bristles 120 may have the straight configuration shown, or may be made with a herringbone configuration, or otherwise.

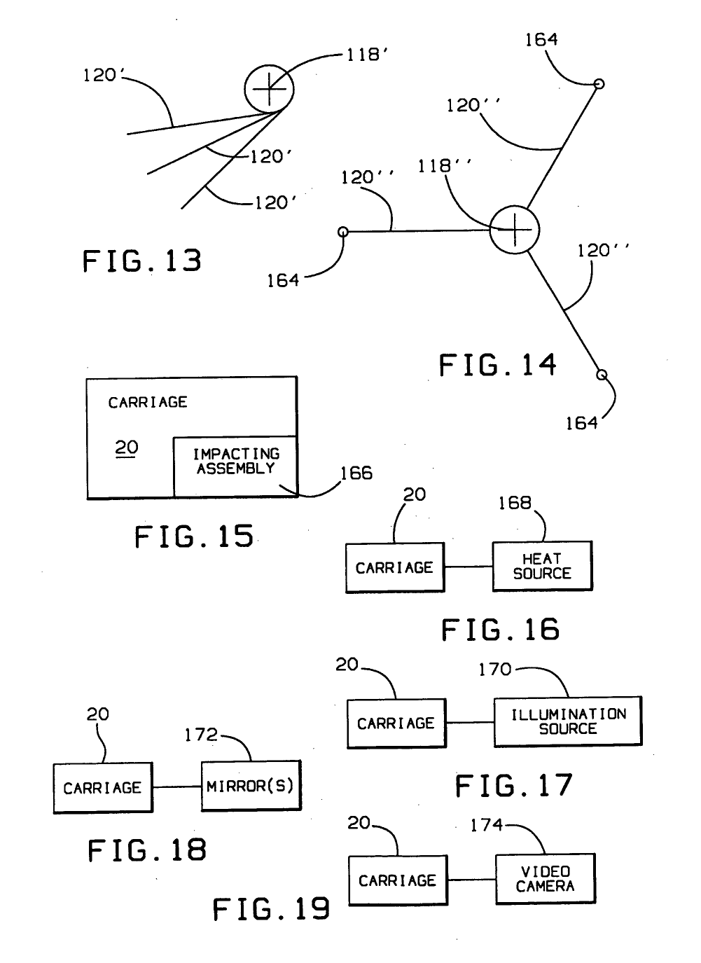

Additionally, while the bristles 120 are shown to extend with their lengths radially aligned with the axis 118, by exposing like bristles 120′ at an angle to the corresponding axis 118′, shown in FIG. 13, the associated treating assembly 12 tends to advance itself by reason of the interaction between the bristles 120′ and the surface 14′ as the bristle support is rotated around its operating axis. This action thus assists the user in advancing the associated treating assembly 12 relative to the surface 14′. This facilitates treatment of the surface 14′ and reduces user fatigue associated with operating the apparatus.

As a further variation, as shown in FIG. 14, the bristles 120″ may have discrete weights 164 at the ends thereof to cause a repetitive impacting of the surface 14′, to produce a hammering action, thereby to break lose foreign material tending to adhere to the surface 14′. When the bristles of a cleaning layer are “tilted” as they are, for example, in the commercially available 3M® Brushlon products, and then vibrated, the magnetic pressure against the wall prevents the assembly from falling and the tilted brushes tend to move it in a direction against the direction of the tilt.

The structure in FIG. 14 represents one form of impacting assembly that can be utilized. In FIG. 15, a more generic disclosure of an impacting assembly is shown at 166 for attachment to the carriage 20, as to produce a hammering action. Structures, other than that shown in FIG. 14, are contemplated, so long as the structure is capable of producing a jarring impact that breaks loose foreign materials.

To assist the treating operation, a heat source 168, shown in FIG. 16, can be provided on the carriage.

As a still further alternative, an illumination source 170, shown in FIG. 17, can be provided on the carriage.

As a further variation, as shown at FIG. 18, at least one mirror 172 can be provided on the carriage 20. The mirror(s) 172 facilitates observation by a user of a surface being treated either before or after treatment thereof.

As a still further variation, in FIG. 19, a video camera 174 is shown mounted to the carriage 20. The video camera 174 facilitates remote viewing of the treating location.

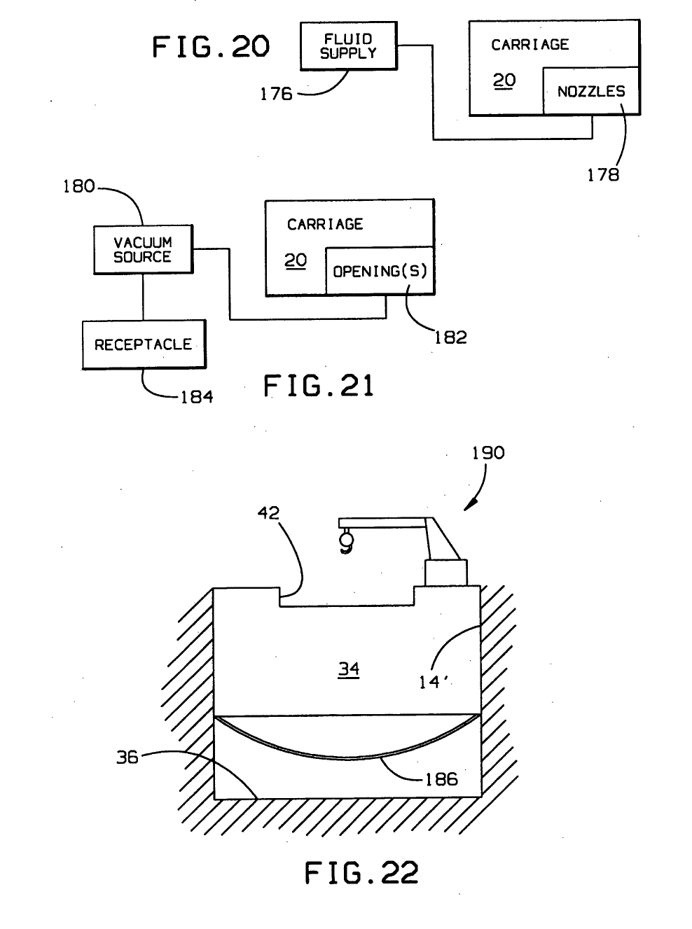

The invention contemplates that functions other than abrasion, as through a device with bristles, be accomplished using the inventive concepts. In FIG. 20, the carriage 20 is shown associated with a supply of pressurized fluid 176. The fluid supply 176 may be directly on the carriage 20 or, alternatively, may be provided at a remote location and communicated to the carriage, as through an appropriate conduit. The carriage 20 has at least one nozzle 178 through which the fluid is directed against the surface 14, 14′. The nature of the fluid in the supply 176 could vary significantly, and may be air, a solvent, steam, or other flowable material, potentially in particulate form. For example, a supply of sand that is used to blast the surface 14, 14′ is considered to be a “fluid” for purposes herein.

As a still further alternative, as shown in FIG. 21, the carriage 20 may be associated with a vacuum source 180 that generates suction at an opening 182 on the carriage 20. The vacuum source 180 again may be directly on the carriage 20 or remote therefrom.

The various components, described above, may be used in any combination, as deemed appropriate. For example, the vacuum source 180 may be used on the carriage 20 in conjunction with a brush/bristled element and/or with the fluid supply 176 to thereby draw, through suction, foreign matter away from the surfaces 14, 14′.

In FIG. 21, the vacuum source may also be associated with a receptacle 184, which allows accumulation of the foreign material that is collected, for appropriate disposal thereof.

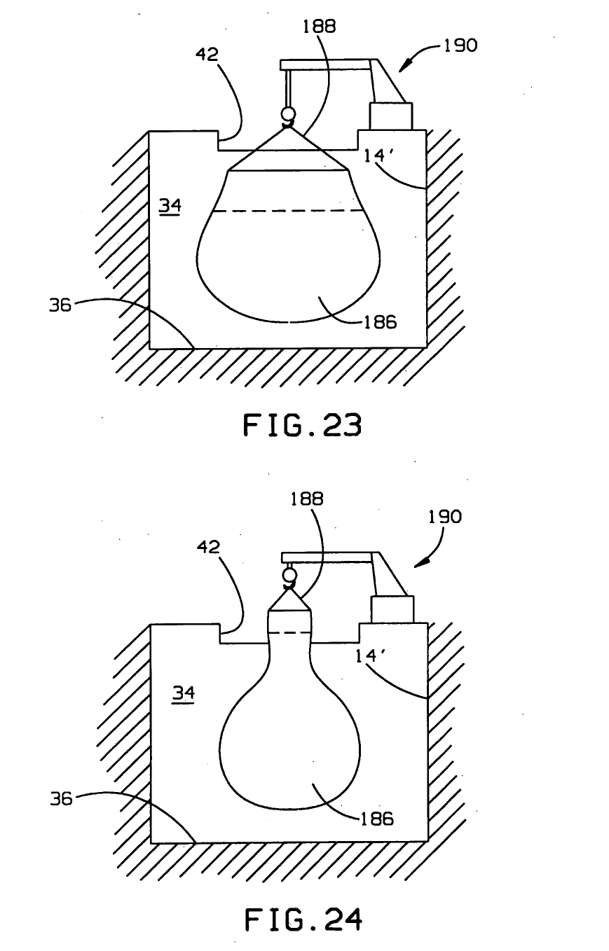

As an alternative to having a discrete receptacle 184, as shown in FIG. 21, a reconfigurable collection element 186 may be provided as shown in FIGS. 22-24. In FIG. 22, the collection element is shown as a reconfigurable, tarp-like structure that covers all or a portion of the floor 36 in the vicinity of where foreign material is broken loose from the surface 14′. As this occurs, the foreign material falls downwardly to against the collection element 186. At a certain point in the procedure, a draw cord 188 is lifted through a boom structure 190 outside of the cargo hold 34. Continued lifting causes the collection element 186 to be reconfigured under the weight of the collected foreign matter to the point that it can pass through the opening 42 for appropriate disposal.

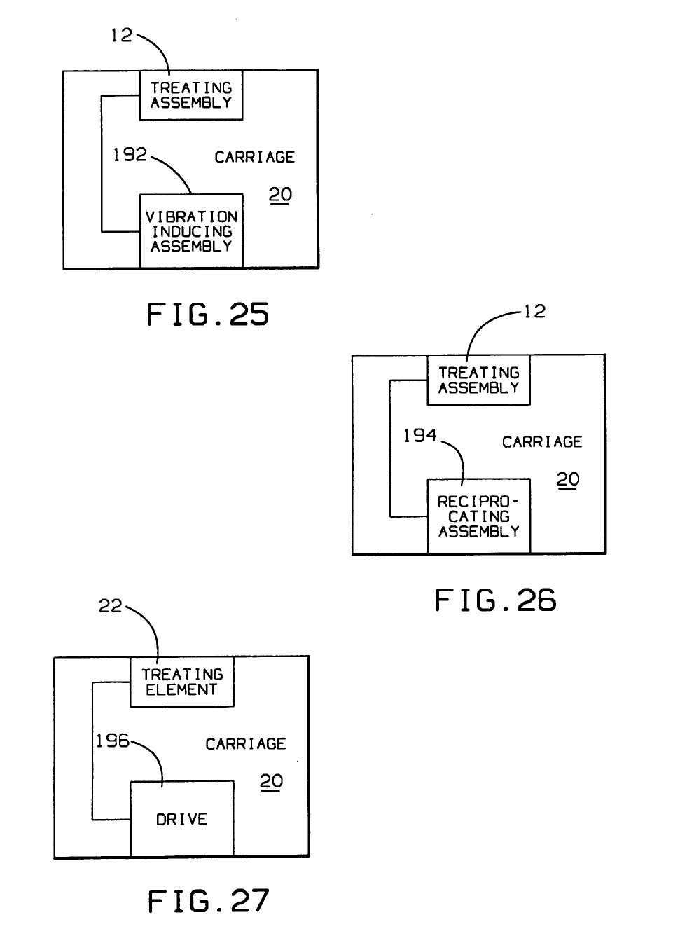

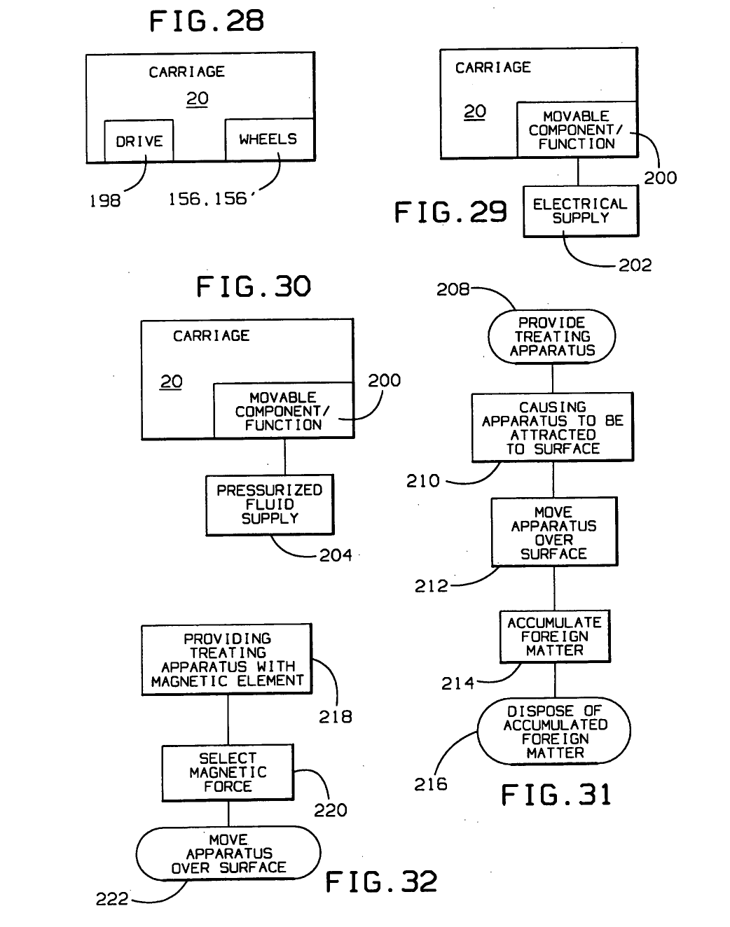

Additional structure is contemplated for enhancing the ability of the treating apparatus 10 to break loose foreign material from the surfaces 14,14′. As shown in FIG. 25, a vibration inducing assembly 192 may be provided on the carriage 22 to induce vibration to part or all of the treating assembly 12 on the carriage 20. This makes possible a scrubbing action, which adds another dimension to the movement of the treating assembly 12 relative to the surface 14, 14′.

As shown in FIG. 26, as an alternative to the vibration inducing assembly 192, a reciprocating assembly can be provided, as shown at 194, to reciprocatively move at least a part of the treating assembly 12 to provide an additional surface treating capability. The reciprocating and vibration inducing assemblies 194, 192 can be used in conjunction with other treating structure on the carriage 20, such as the structure in FIG. 20, wherein nozzles 178 direct pressurized fluid against the surface 14, 14′. In short, the invention contemplates virtually any single or multiple dimensional movement of the treating element 22 on the carriage 20. This generic concept is shown schematically in FIG. 27, wherein a drive 196 is associated with the treating element 22 to effect single or multi-dimensional movement i.e. vibrational and translational movement, or otherwise.

To assist operation of the apparatus 10, and avoid user fatigue, the wheels 156, 156′ on the carriage 120 may be driven, as through a drive 198, to make the apparatus 10 either full time, or selectively, self-propelled.

As shown in FIG. 29, it is contemplated that any movable component/function carriage 20, shown generically at 200, could be operated electrically through an appropriate supply 202, that may be self-contained or otherwise designed. Alternatively, as shown in FIG. 30, the same function can be accomplished pneumatically or hydraulically using a pressurized fluid supply 204.

A method of using the above-described apparatus will now be described with respect to a flow diagram, shown in FIG. 31. As shown at block 208, the treating apparatus is provided. The treating apparatus has a carriage with a treating assembly on the carriage. As shown at block 210, the apparatus is caused to be attracted to the surface to be treated. This may be accomplished magnetically, in the event of a ferrous surface, or otherwise, as by suction, in the event that the surface to be treated is non-ferrous in nature. As shown at block 212, the apparatus is moved over a surface, to effect treatment thereof, through manual orientation of the apparatus through application of a maneuvering force by a user from a location spaced from the carriage, that allows controlled movement of the apparatus over the surface. The step of causing the apparatus to be attracted to the surface may involve initially placing the apparatus against the surface using an elongate pole. Alternatively, a pole can be connected after the apparatus is placed against the surface. As shown at block 214, any foreign matter removed from the surface 14, 14′ can be accumulated and disposed of appropriately, as shown in block 216. The accumulation may be carried out, as by using a receptacle 184, as shown in FIG. 21, utilizing the collecting element 186, as shown in FIGS. 22-24, or otherwise.

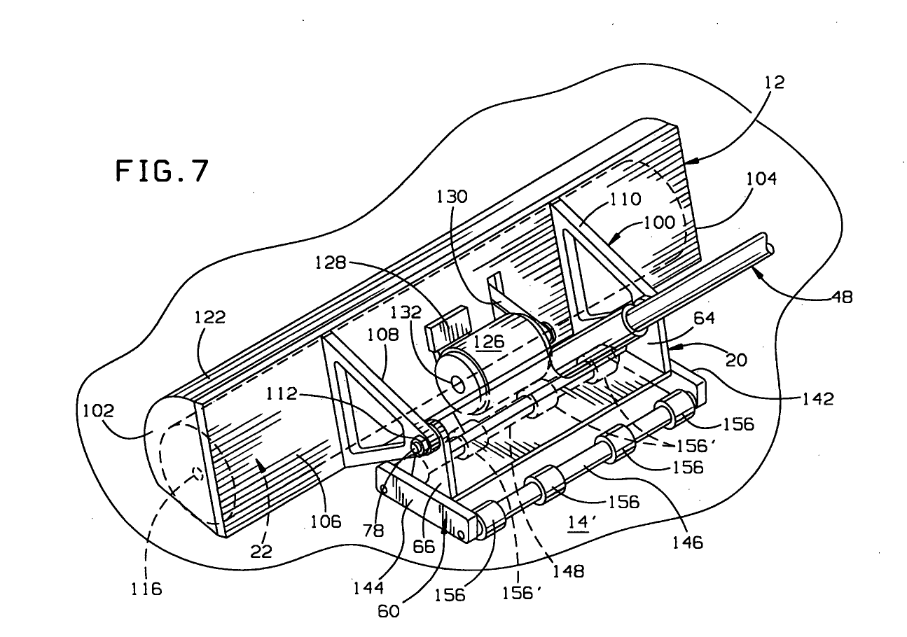

The invention also contemplates that the attractive force, as effected through a magnetic element, may be varied, as shown in the flow diagram of FIG. 32. The treating apparatus is provided with a magnetic element, as shown at block 218. With an apparatus as shown in FIGS. 7-12, wheels/shafts 146, 148 may be provided with different configurations, as by using a different number of magnetic wheel elements 156, 156′, and/or by using magnetic elements having different strengths. Depending upon the application, and the weight of the apparatus, an appropriate magnetic force is selected, as shown at block 220. After installation of the appropriate wheel/shaft, the apparatus is moved over a surface to be treated, as shown at block 222.

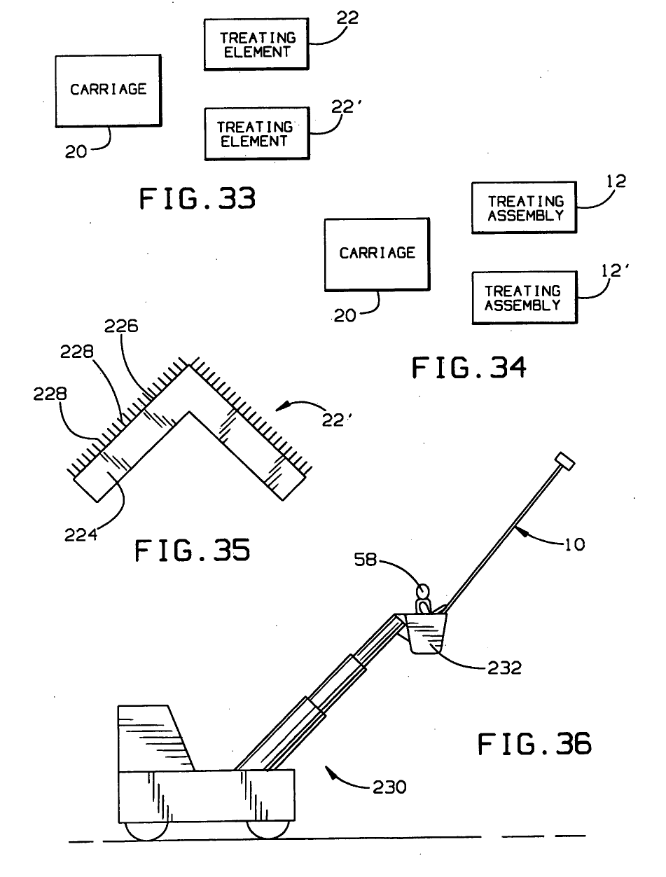

As shown in FIG. 33, kits can be provided, including treating elements 22, 22′ having different configurations. Treating elements 22, 22′ can be interchangeably mounted into an operative position on the carriage.

Alternatively, as shown in FIG. 34, a kit can be provided wherein entire treating assemblies 12, 12′ are interchangeably mounted on the carriage 20, depending upon the particular job application or configuration of a surface being treated.

As an example, as shown in FIG. 35, a treating element 22′ is shown as having a base 224 with a V-shaped surface 226 with bristles 228 thereon to facilitate cleaning a juncture of transverse surfaces, such as at an inside corner. Myriad other treating element configurations are contemplated by the invention for treating contoured surfaces or surfaces that may be difficult to access.

Access may also be facilitated by using a human lift device, as shown in FIG. 36 at 230. The lift device 230 has a bucket 232 within which the user 58 can be situated to operate the apparatus 10 from an elevated position.

The invention also contemplates that an additional step may be carried out preparatory to using the apparatus 10, as described above. As shown in FIG. 37, an impact/vibration inducing device 234 may be used and placed against the cargo ship 28 strategically, as at an external location on the hull, or internally of the cargo hold 34. This action provides a preliminary breaking up of the foreign material adhered to the surface 14′, after which the aforementioned cleaning steps may be carried out.

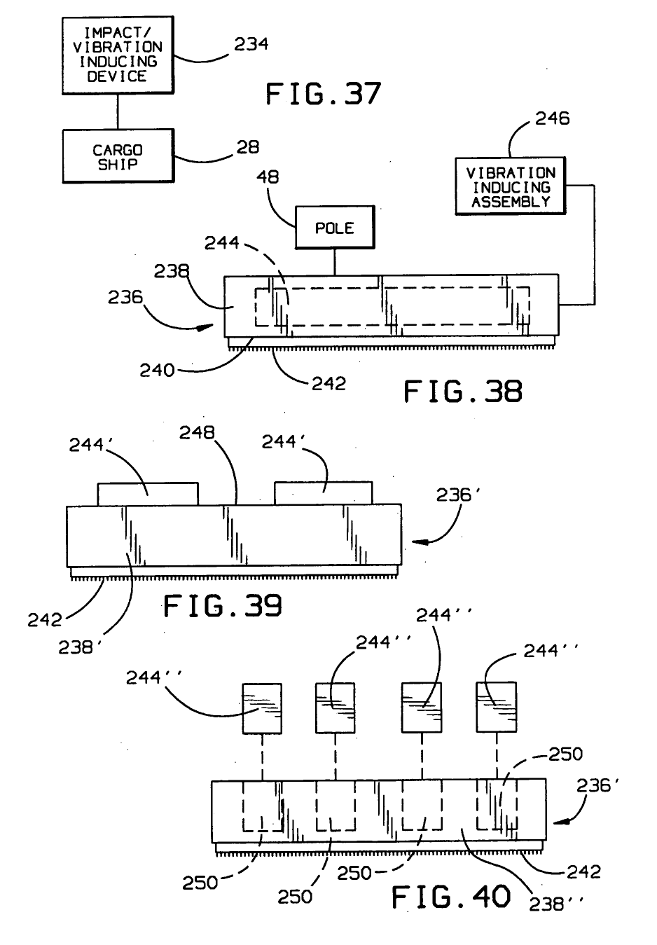

As shown in FIG. 38, the invention also contemplates that, as an alternative to using a bristled treating element, a pad, as shown at 236, may be utilized. The pad 236 consists of a core element 238, that is preferably made from a non-ferrous material. At least one exposed surface 240 of the core element 238 has a surface treating layer 242 applied thereto. At least one magnetic element 244 is provided on the core element 238. In this construction, the magnetic element 244 is embedded in the core element 238. The surface treating layer 242 can be provided on any or all exposed surfaces on the core element 238.

In one form, the surface treating layer 242 is at least one of a) sandpaper; b) an absorbent pad; c) a bristled layer; d) a layer of a hook component of a hook and loop fastener system; and e) a non-skid layer. In operation, the surface with the surface treating layer 242 is then applied to the surface 14′ to be treated. The pad 236 may be manipulated through the aforementioned pole 48.

To enhance treatment, a vibration-inducing assembly 246 may be provided to vibrate the core element 238. This produces a scrubbing action.

In FIG. 39, a modified form of pad is shown at 236′ with a core element 238′ having magnetic elements 244′ attached on an external surface 240 thereon. A surface treating layer 242 is applied to at least one surface of the core element 238′.

In FIG. 40, a further modified form of pad is shown at 236″ with a core element 238″ having a series of receptacles 250 into which magnetic elements 244″ can be placed. The magnetic elements 244″ can be placed in one or all of the receptacles 250 to select the desired attractive force between the pad 236″ and the surface 14′. A surface treating layer 242 is provided on the core element 238″.

It should be understood that the use of a pad can be practical to treat a non-ferrous material. Attraction can be generated between the pad and surface 14, as by the use of suction.

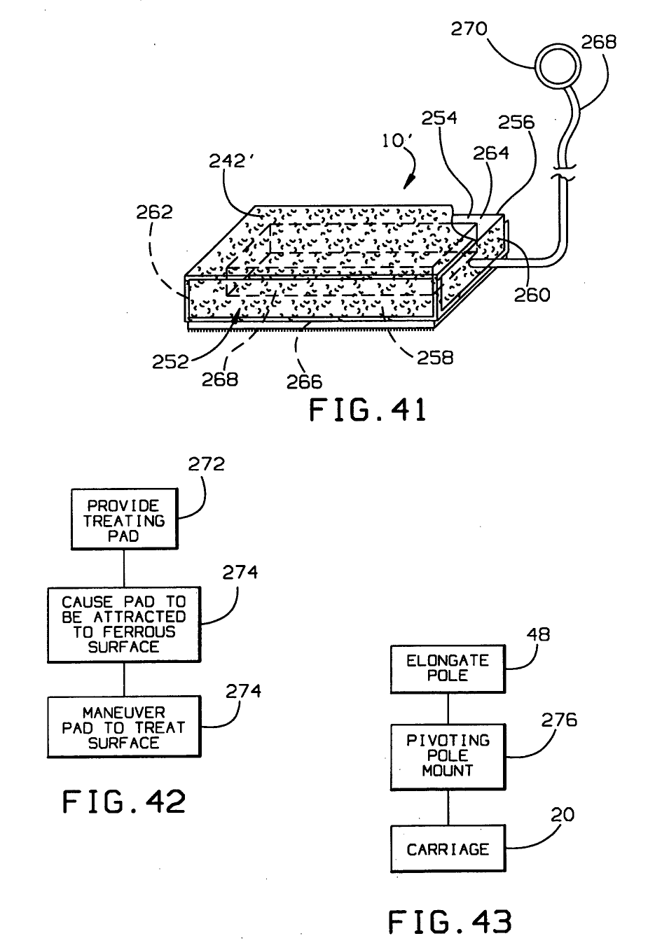

In FIG. 41, a further modified form of treating apparatus, according to the present invention, is shown at 10′. The apparatus 10′ consists of a pad 252 with a core element 254, made preferably from a non-ferrous material, and having a series of flat sides. In this embodiment, the core element 254 has a squared block shape with six, flat, exposed surfaces 256, 258, 260, 262, 264, 266. On each of the exposed surfaces 256-266, a surface treating layer 242′ is applied, corresponding to the surface treating layer 242.

A magnetic element 268 is embedded in the core element 254 and has a strength, configuration, and location within the core element 254, so as to support the weight of the core element 254 against a ferrous surface.

With the pad 252, the user can place any of the surfaces 256-266 against a ferrous surface, to be attracted thereto. Through a flexible cord 268, the user can draw the pad 252 over the surface to effect treatment thereof. A fitting, such as a ring 270 can be provided to facilitate maneuvering of the pad 252, by drawing the same through the flexible cord 268.

For purposes of consistency in the claims, the core elements 238,238′, 238″, 254 will be considered a “carriage”. The “carriage” is maneuvered by the user in all embodiments to effect treating of a surface 14, 14′.

Using the pad 252, a treating process can be carried out, as shown in flow diagram form in FIG. 42. As shown at block 272, a pad is provided. As shown at block 274, the pad is caused to be attracted to a ferrous surface by either placing the pad against such a surface or by propelling the same towards the surface, wherein it becomes magnetically attracted thereto. As shown at block 274, the pad is then maneuvered to treat the surface.

With this embodiment, the pad 252 can be made to be sufficiently light in weight that it can be propelled/thrust at a surface, such as a high ceiling or difficult to reach location. The user can then simply maneuver the pad 252 through the flexible core 268 to effect the desired treatment of the surface 14′.

A still further variation, according to the present invention, is shown in FIG. 43. In FIG. 43, an elongate pole 48 is shown attached to the carriage 20 through a pivoting pole mount 276, that allows at least two degrees of movement of the pole 48 relative to the carriage 20. As seen in FIG. 7, the pole 48 is mounted to the carriage 20 for movement relative thereto about a single pivot axis. By adding another dimension of movement, the treating assembly 12 on the carriage 20 is allowed to conform more readily to surfaces when applied from potentially awkward angles. In one preferred form, the pivoting pole mount permits universal pivoting of the mounting end 52 of the pole 48 relative to the carriage 20.

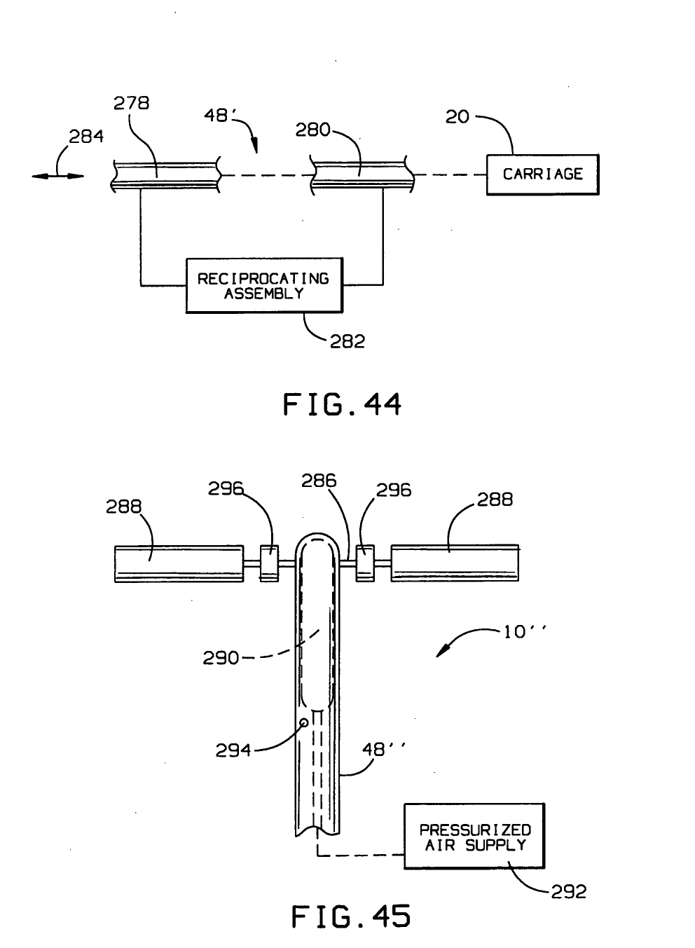

In FIG. 44, a modified form of elongate pole 48′ is shown and includes separate sections 278, 280, which are movable, each relative to the other. Through a reciprocating assembly 282, the section 278 is moved reciprocatingly in the line of the double-headed arrow 284 relative to the section 280. This produces a repeating force against the carriage 20 to which the section 280 is connected. Alternatively, the reciprocating assembly 282 may act between the elongate pole 48 and a mount upon the carriage 20. The structures in FIGS. 43 and 44 may be used on any of the embodiments described above.

In FIG. 45, a modified form of treating apparatus is shown at 10″. The apparatus 10″ has an elongate pole 48″ with a shaft 286 extending substantially orthogonally to the length of the pole 48″. Separate treating elements 288, of like construction, are attached to the shaft, where it projects oppositely from the connection to the pole 48″. The treating elements 288 may have bristles, abrasive material, etc. The shaft 286 is rotated by an air motor 290, which is driven through air from a pressurized supply 292. An air outlet 294 is provided in the pole 48″.

Magnetic wheels 296 are provided on opposite sides of the pole 48″. The wheels 296 are preferably made from a magnetic material or incorporate magnets to produce an attractive force with respect to a ferrous surface.

As noted previously, many of the mechanisms and components are shown schematically in the attached figures. That is because, using the inventive concept, the form of the apparatus and components may vary significantly. The depicted structures that are shown in detail are intended only to be exemplary in nature.

The foregoing disclosure of specific embodiments is intended to be illustrative of the broad concepts comprehended by the invention.

1. A method of treating a ferrous surface, the method comprising the steps of:
providing an apparatus comprising a carriage and a treating assembly on the carriage;
causing the apparatus to be attracted to the ferrous surface with a force that tends to maintain the apparatus against the ferrous surface yet allows the apparatus to move over the ferrous surface; and
moving the apparatus over the ferrous surface to effect treating of the ferrous surface with the treating assembly through manual orientation and movement of the apparatus by a user through application of a maneuvering force from a location spaced from the carriage that allows controlled movement of the apparatus over the ferrous surface.

2. The method of treating a ferrous surface according to claim 1 wherein the step of providing an apparatus comprises providing an apparatus with at least one wheel that rolls against the ferrous surface.

3. The method of treating a ferrous surface according to claim 1 wherein the step of causing the apparatus to be attracted to the ferrous surface comprises causing the apparatus to be magnetically attracted to the ferrous surface.

4. The method of treating a ferrous surface according to claim 1 wherein the ferrous surface defines a wall bounding a cargo hold in a ship.

5. The method of treating a ferrous surface according to claim 1 wherein the step of moving the apparatus over the ferrous surface comprises moving the apparatus over the ferrous surface using a flexible cord.

6. The method of treating a ferrous surface according to claim 1 wherein the step of moving the apparatus over the ferrous surface comprises moving the apparatus over the ferrous surface using an elongate pole.

7. The method of treating a ferrous surface according to claim 1 wherein the step of providing an apparatus comprises providing an apparatus with a treating assembly that comprises a bristled element.

8. The method of treating a ferrous surface according to claim 1 wherein the step of providing an apparatus comprises providing an apparatus with a treating assembly that comprises a rotary brush.

9. The method of treating a ferrous surface according to claim 1 wherein the step of providing an apparatus comprises providing an apparatus with a treating assembly comprising a treating element that is movable relative to the carriage.

10. The method of treating a ferrous surface according to claim 1 further comprising the step of urging at least a part of the treating assembly in movement relative to the carriage to bias a treating element on the treating assembly against the ferrous surface.

11. The method of treating a ferrous surface according to claim 1 further comprising the step of inducing vibration to a treating element on the treating assembly.

12. The method of treating a ferrous surface according to claim 9 wherein the step of providing an apparatus comprises providing an apparatus with a drive element on the carriage for causing the treating element to be moved relative to the carriage.

13. The method of treating a ferrous surface according to claim 2 further comprising the step of driving the at least one wheel to cause the apparatus to move over the ferrous surface.

14. The method of treating a ferrous surface according to claim 1 wherein the step of providing an apparatus comprises providing an apparatus comprising a treating assembly that discharges a fluid against the ferrous surface.

15. The method of treating a ferrous surface according to claim 1 wherein the step of providing an apparatus comprises providing an apparatus comprising a treating assembly with a treating element that repetitively impacts the ferrous surface to produce a hammering action.

16. The method of treating a ferrous surface according to claim 1 wherein the step of providing an apparatus comprises providing an apparatus with a treating assembly that is electrically powered.

17. The method of treating a ferrous surface according to claim 1 wherein the step of providing an apparatus comprises providing an apparatus with a treating assembly that is pneumatically powered.

18. The method of treating a ferrous surface according to claim 6 further comprising the step of placing the apparatus from a separated position to against the ferrous surface using the elongate pole.

19. The method of treating a ferrous surface according to claim 6 further comprising the step of providing a supplemental support system and through the supplemental support system facilitating movement of the apparatus in conjunction with the elongate pole.

20. The method of treating a ferrous surface according to claim 19 wherein the step of providing a supplemental support system comprises providing at least one flexible element and the step of facilitating movement of the apparatus comprises exerting an upward force on the apparatus.

21. The method of treating a ferrous surface according to claim 1 further comprising the step of selectively varying the force that tends to maintain the apparatus against the ferrous surface.

22. The method of treating a ferrous surface according to claim 7 wherein the step of providing an apparatus with a bristled element comprises providing an apparatus with a bristled element that is movable to advance the carriage independently of a force exerted by the user tending to move the treating apparatus relative to the ferrous surface.

23. The method of treating a ferrous surface according to claim 1 wherein the step of providing an apparatus comprises providing an apparatus comprises a non-ferrous core element with a surface treating layer applied over the core element.

24. The method of treating a ferrous surface according to claim 23 wherein the step of providing an apparatus comprising providing an apparatus with a surface treating layer that comprises at least one of: a) sandpaper; b) an absorbent pad; c) a bristled layer; d) a layer of a hook component of a hook and loop fastener system; e) a non-skid layer; f) a squeegee; and g) an absorbent pad.

25. The method of treating a ferrous surface according to claim 1 further comprising the step of applying a treating substance to the ferrous surface through the treating assembly.

26. The method of treating a ferrous surface according to claim 1 further comprising the step of heating the ferrous surface through a heat source on the carriage.

27. The method of treating a ferrous surface according to claim 1 wherein the step of providing an apparatus comprises providing an apparatus with treating elements that are interchangeably mountable in an operative position on the carriage.

28. The method of treating a ferrous surface according to claim 1 wherein the step of providing an apparatus comprises providing an apparatus with a treating element that is contoured to engage and conform to other than a flat surface.

29. The method of treating a ferrous surface according to claim 1 wherein the step of providing an apparatus comprises providing an apparatus through which suction can be generated to controllably draw foreign matter away from the ferrous surface.

30. The method of treating a ferrous surface according to claim 1 wherein the step of providing an apparatus comprises providing an apparatus with a source of illumination on the carriage.

31. The method of treating a ferrous surface according to claim 1 wherein the step of providing an apparatus comprises providing an apparatus with a video camera on the carriage to facilitate viewing by a user of a treating process.

32. The method of treating a ferrous surface according to claim 1 wherein the step of providing an apparatus comprises providing an apparatus with at least one mirror on the carriage that facilitates observation by a user of the ferrous surface either before or after treatment thereof.

33. The method of treating a ferrous surface according to claim 1 further comprising the steps of providing at least one collection element, causing foreign matter removed from the ferrous surface to be directed against the collection element as it is removed, and reconfiguring and relocating the collection element with accumulate foreign matter.

34. The method of treating a ferrous surface according to claim 4 further comprising the steps of providing a human lift device and operating the apparatus from the human lift device.

35. The method of treating a ferrous surface according to claim 4 further comprising the step of repetitively impacting the ferrous surface to produce a hammering action preparatory to using the apparatus.

36. The method of treating a ferrous surface according to claim 4 further comprising the step of inducing vibration to a portion of the ship preparatory to using the apparatus.

37. An apparatus for treating a ferrous surface, the apparatus comprising:
a carriage;
a treating assembly on the carriage; and
a magnetic assembly for attracting the apparatus to a ferrous surface with a force tending to maintain the apparatus against the ferrous surface yet allow the apparatus to move over the ferrous surface,
the overall apparatus configured to be movable over a ferrous surface and controllably reoriented and moved through the application of a maneuvering force upon the apparatus by a user from a location spaced from the carriage.

38. The apparatus for treating a ferrous surface according to claim 37 further comprising an elongate pole attached to the carriage and through which a user can apply the maneuvering force.

39. The apparatus for treating a ferrous surface according to claim 37 further comprising a flexible element attached to the carriage and through which a user can apply the maneuvering force.

40. The apparatus for treating a ferrous surface according to claim 37 wherein the carriage has at least one wheel that rolls against a surface to be treated.

41. The apparatus for treating a ferrous surface according to claim 37 wherein the treating assembly comprises a bristled element.

42. The apparatus for treating a ferrous surface according to claim 37 wherein the treating assembly comprises a rotary element.

43. The apparatus for treating a ferrous surface according to claim 42 wherein the rotary element has bristles thereon that are orientated to cause the rolling element to generate a force that tends to advance the apparatus over a surface to be treated as the rotary element is operated.

44. The apparatus for treating a ferrous surface according to claim 37 wherein the treating assembly comprises a treating element that is movable relative to the carriage and further comprising a biasing assembly through which a force is exerted on the treating element tending to move the treating element relative to the carriage.

45. The apparatus for treating a ferrous surface according to claim 37 further comprising a vibration generator through which the treating element is vibrated.

46. The apparatus for treating a ferrous surface according to claim 40 further comprising a drive for rotating the at least one wheel.

47. The apparatus for treating a ferrous surface according to claim 37 further comprising a fluid discharge assembly through which a fluid under pressure is discharged at a treating location.

48. The apparatus for treating a ferrous surface according to claim 47 wherein there is a discharge nozzle on the carriage through which the fluid under pressure can be directed at a surface to be treated.

49. The apparatus for treating a ferrous surface according to claim 37 further comprising an impact assembly on the carriage for repetitively impacting a surface to be treated to produce a hammering action.

50. The apparatus for treating a ferrous surface according to claim 37 wherein the treating apparatus has at least one movable component and that at least one movable component is driven electrically.

51. The apparatus for treating a ferrous surface according to claim 37 wherein the treating apparatus has at least one movable component and that at least one movable component is driven pneumatically.

52. The apparatus for treating a ferrous surface according to claim 37 wherein the magnetic assembly comprises at least two magnets that can be interchangeably mounted on the carriage.

53. The apparatus for treating a ferrous surface according to claim 37 wherein the carriage has receptacles for a plurality of magnetic elements defining the magnetic assembly and the attracting force is variable by at least one of: a) changing the number of magnetic elements placed in the receptacles; b) using magnetic elements with different capacities; and c) changing the distance between the magnetic elements and a surface that is treated.

54. The apparatus for treating a ferrous surface according to claim 37 wherein the carriage comprises a non-ferrous core element to which a surface treating layer is applied.

55. The apparatus for treating a ferrous surface according to claim 54 wherein the surface treating layer comprises at least one of: a) sandpaper; b) an absorbent pad; c) a bristled layer; d) a layer of a hook component of a hook and loop fastener system; and e) a non-skid layer.

56. The apparatus for treating a ferrous surface according to claim 37 wherein the apparatus further comprises a heat source on the carriage.

57. The apparatus for treating a ferrous surface according to claim 37 wherein the treating assembly comprises a treating element that is releasably mountable in an operative position on the carriage and further in combination with a second treating element that can be mounted in an operative position on the carriage.

58. The apparatus for treating a ferrous surface according to claim 57 wherein the first claimed and second treating elements have a different configuration.

59. The apparatus for treating a ferrous surface according to claim 37 wherein the apparatus comprises a vacuum source for generating suction at an area being treated to thereby draw away foreign matter separated from a surface being treated.

60. The apparatus for treating a ferrous surface according to claim 37 further comprising a source of illumination on the carriage.

61. The apparatus for treating a ferrous surface according to claim 37 further comprising at least one mirror on the carriage that facilitates observation by a user of a surface being treated either before or after treatment thereof.

62. The apparatus for treating a ferrous surface according to claim 37 further comprising a video camera on the carriage to facilitate viewing of a treating process by a user.

63. The apparatus for treating a ferrous surface according to claim 37 wherein the apparatus comprises a collection receptacle, and foreign matter separates by the treating assembly is directed into the collection receptacle.

64. The apparatus for treating a ferrous surface according to claim 37 wherein the treating assembly is vibrated relative to the carriage to facilitate treating of a ferrous surface.

65. The apparatus for treating a ferrous surface according to claim 37 wherein the treating assembly is movable reciprocatively relative to the carriage to facilitate treating of a ferrous surface.

66. The apparatus for treating a ferrous surface according to claim 40 further comprising a drive for the at least one wheel.
